(19) United States
(12) Patent Application Publication
(10) Pub. No.: US 2002/0169629 A1
(43) Pub. Date: Nov. 14, 2002

(54) Raising intermediation method, raising intermediation program, and recording medium

(75) Inventor: Tadashi Taoka, Obihiro (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/108,331

(22) Filed: Mar. 29, 2002

(30) Foreign Application Priority Data
Apr. 3, 2001 (JP) 2001-105094

(51) Int. Cl. G06F 17/60

(52) U.S. Cl. 705/1

(57) ABSTRACT

A method of performing intermediation in raising a product includes the steps of (a) informing a raising site of an instruction transmitted from a user and (b) paying or charging the user based on a balance after deducting a fee for the raising site and an intermediation commission from proceeds from a sale of the product sold in accordance with the instruction of the user. The steps (a) and (b) are performed electrically via a network.

### BACKGROUND OF THE INVENTION

1. Field of the Invention

The present invention generally relates to raising intermediation methods, raising intermediation programs, and recording media, and more particularly to a raising intermediation method for performing intermediation in raising products, a raising intermediation program for executing such a method, and a recording medium storing such a program.

2. Description of the Related Art

Conventionally, people engaged in raising field crops, flowers, fish, or trees have employed professional knowledge accumulated over a long period of time, a variety of instruments, and resources such as cultivated land in order to raise products, and have gained income by shipping the products such as field crops to market, thereby conducting business.

Further, as pertaining to leisure farming, some professional raisers provide their professional knowledge and a variety of instruments to customers so that the customers themselves enjoy raising field crops for personal consumption and as gifts to their friends.

However, as described above, in the conventional raising of agricultural products or the like pertaining to leisure farming, the professional raisers only provide their professional knowledge and the instruments to the customers so that the customers may enjoy raising the field crops for personal consumption, with the result that their professional knowledge, instruments, and cultivated land are not fully utilized.

### SUMMARY OF THE INVENTION

Accordingly, it is a general object of the present invention to provide a raising intermediation method by which the above-described disadvantage is eliminated.

A more specific object of the present invention is to provide a raising intermediation method that organically intermediates between a raising site raising a variety of products and a user playing a key management role so that raising, sale, and settlement can be realized with efficiency and simplicity.

Another more specific object of the present invention is to provide a program for executing such a raising intermediation method and a recording medium storing such a program.

The above objects of the present invention are achieved by a method of performing intermediation in raising a product, the method including the steps of (a) informing a raising site of an instruction transmitted from a user and (b) paying or charging the user based on a balance after deducting a fee for the raising site and an intermediation commission from proceeds from a sale of the product sold in accordance with the instruction of the user, wherein the steps (a) and (b) are performed electrically via a network.

The above objects of the present invention are also achieved by a method of performing intermediation in raising a product, the method including the steps of (a) informing a user of harvest information transmitted from a raising site with sales conditions being added to the harvest information as required and (b) informing the raising site of a response from the user to the sales conditions so that the raising site sells the product in accordance with the response from the user, wherein the steps (a) and (b) are performed electrically via a network.

The above objects of the present invention are also achieved by a method of performing intermediation in raising a product, the method including the steps of (a) informing a user of one or both of advice on raising the product transmitted from a raising site and advice on raising the product created by referring to a database and (b) informing the raising site of a response from the user to the advice so that the raising site raises the product in accordance with the response from the user, wherein the steps (a) and (b) are performed electrically via a network.

According to the above-described methods, organic intermediation is provided between the raising site and the user so that raising, sale, and settlement can be realized with efficiency and simplicity.

The above objects of the present invention are also achieved by a program for performing intermediation in raising a product, the program causing a computer to execute the steps of (a) informing a raising site of an instruction transmitted from a user and (b) paying or charging the user based on a balance after deducting a fee for the raising site and an intermediation commission from proceeds from a sale of the product sold in accordance with the instruction of the user, wherein the steps (a) and (b) are performed via a network.

The above objects of the present invention are further achieved by a computer-readable recording medium storing a program for performing intermediation in raising a product, the program causing a computer to execute the steps of (a) informing a raising site of an instruction transmitted from a user and (b) paying or charging the user based on a balance after deducting a fee for the raising site and an intermediation commission from proceeds from a sale of the product sold in accordance with the instruction of the user, wherein the steps (a) and (b) are performed via a network.

### BRIEF DESCRIPTION OF THE DRAWINGS

Other objects, features and advantages of the present invention will become more apparent from the following detailed description when read in conjunction with the accompanying drawings, in which:

FIG. 1 is a diagram showing a system structure according to an embodiment of the present invention;

FIG. 2A is a flowchart of a registration-related operation of a system of the present invention and FIG. 2B is a diagram showing a customer database;

FIG. 3 is a flowchart of a general operation of the system of the present invention;

FIG. 4 is a flowchart of a raising-related operation of the system of the present invention;

FIG. 5 is a diagram showing advice information of the present invention;

FIG. 6 is a flowchart of a harvest-related operation of the system of the present invention;

FIGS. 7A and 7B are diagrams showing harvest information and purchase information of the present invention;

FIG. 8 is a flowchart of a settlement-related operation of the system of the present invention; and

FIG. 9 is a flowchart of a billing-related operation of the system of the present invention.

### DETAILED DESCRIPTION OF THE PREFERRED EMBODIMENTS

Next, a description will be given, with reference to the accompanying drawings, of an embodiment of the present invention.

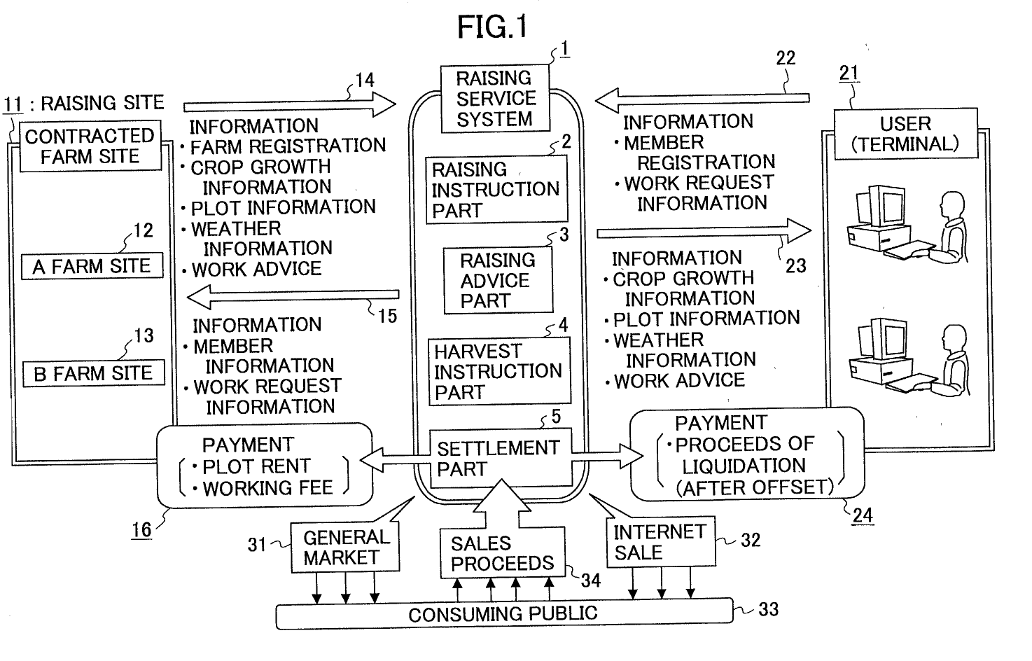

FIG. 1 is a diagram showing a system structure according to the embodiment of the present invention.

In FIG. 1, a raising service system 1 intermediates on-line between a raising site 11 and a user terminal 21 via a network such as the Internet. The raising service system 1 includes a raising instruction part 2, a raising advice part 3, a harvest support part 4, and a settlement part 5.

The raising site 11 is a site for raising products such as field crops, livestock, trees, garden products, or fish (young yellowtail, tuna, salmon, or trout). However, in this embodiment, a description will be given, for the purpose of simplicity, of the operations of raising, harvesting, and selling a field crop by using farmland resources.

The raising instruction part 2 transmits an instruction on raising to the raising site 11 based on an instruction transmitted from the user terminal 21 of a raising-contracted user.

The raising advice part 3 informs the user terminal 21 of raising advice based on the past record created and provided by the raising site 11 or the raising advice of the last year fetched from a database. Further, the raising advice part 3 displays the provided raising advice and receives a response from the user in which selection or correction is made. Then, the raising advice part 3 informs the raising site 11 of the received response and causes the raising site 11 to work accordingly.

The harvest instruction part 4 adds purchase information to harvest information created by the raising site 11 and informs the user terminal 21 of the information. Further, harvest instruction part 4 displays the information and receives a response including selection and/or correction from the user. Then, the harvest instruction part 4 informs the raising site 11 of the received response and instructs the raising site 11 to make shipment.

The settlement part 5 settles an account by deducting a raising fee (composed of various work fees) and an intermediation commission from proceeds 34 from the sale of the raised product (field crop).

The raising site 11, which is connected to the raising service system 1 via a network such as the Internet, raises, harvests, and sells the field crop specified by the user. Here, the raising site 11 controls a plurality of farm sites such as an A farm site 12 and a B farm site 13. Alternately, the raising site 11 may be an independent farm site managed by the raising service system 1.

Each of the farm sites 12 and 13 is a group of professionals that has farmland and a variety of agricultural instruments as resources and professional knowledge based on experience, and raises the specified field crop by using these resources and knowledge.

Information 14, which is an example of information that the raising site 11 registers with or transmits to the raising service system 1, includes the following:

farm registration

crop growth information

plot information

weather information

work advice (a raising advice on additional manure, etc.)

others.

Information 15, which is an example of information that the raising site 11 receives from the raising service system 1, includes the following:

member information (information on a member or user who becomes the owner of a raised crop)

work request information

others.

Payment 16 includes a plot rent and a working fee and is deducted from the proceeds 34 from the sale of the field crop that is the raised product.

The user terminal 21, which is connected to the raising service system 1 via a network such as the Internet, makes a contract and gives instructions on raising, harvesting, and selling the field crop.

Information 22, which is an example of information that the user provides to the raising service system 1, includes the following:

member registration

work request information

others.

Information 23, which is an example of information that the user terminal 21 receives from the raising service system 1, includes the following:

crop growth information

plot information

weather information

work advice (raising advice on additional manure, etc.)

others.

Payment 24 is the proceeds of liquidation received by the user after an offset. That is, payment 24 is a balance remaining after the fee payment to the raising site 11 and the commission payment to the raising service system 1 are deducted from the sales proceeds 34.

A general market 31 is an example of a sales place for selling the harvest to the consuming public 33.

An Internet sale 32 is a system that sells the harvest directly to the consuming public 33 via the Internet.

The consuming public 33 are people that consume the field crop raised in the raising site 11.

The sales proceeds 34 are proceeds from the sale of the harvested field crop in the general market 31 or through the Internet sale 32.

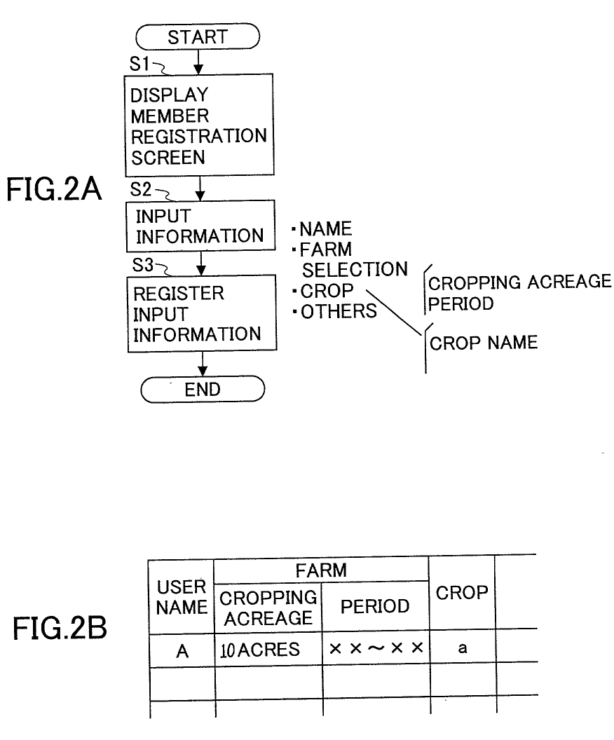

Next, a description will be given, with reference to FIGS. 2A through 8, of an operation of the system of FIG. 1.

FIGS. 2A and 2B are diagrams for illustrating registration according to this embodiment.

FIG. 2A is a flowchart of the registration.

In step S1, a member registration page is displayed. In step S2, inputs are made. In steps S1 and S2, the user terminal 21 is operated to be connected to the raising service system 1 via the Internet, and the member registration page is downloaded from a Web server to be displayed on the screen of the user terminal. Then, the following information is input to the member registration page on the screen (member registration screen).

name

farm selection (cropping acreage, period)

crop (crop name)

others.

In step S3, the input information is registered. That is, after the user inputs the information on the member registration screen in step S2, the user presses a registration button to register the information with the raising service system 1 via the Internet. Thereby, the user requests cultivation of the specified field crop for a specified period of time in a specified farm under selected and input conditions on a contract basis. These registered contents are recorded and managed in a later-described customer database shown in FIG. 2B in the raising service system 1.

Thus, the user is enabled to entrust raising of the crop to the raising service system 1 by specifying the farm, cropping (crop raising) acreage, period, and crop on the displayed member registration screen downloaded from the Web server of the raising service system 1 to which server the user terminal 21 is connected.

FIG. 2B is a diagram showing the customer database of the raising service system 1. The contents (user name (customer name), farm (cropping acreage, period), crop, others) input in step S2 are registered in the customer database in step S3 so as to be correlated with each customer (user) as shown in FIG. 2B.

Thus, by managing the cropping request information (farm, cropping acreage, period, crop) by registering the information with the customer database, the raising service system 1 of FIG. 1 is enabled, with respect to a plurality of farms, to manage all crop-raising requests made by a plurality of users in accordance with their requests and give each farm instructions on cropping.

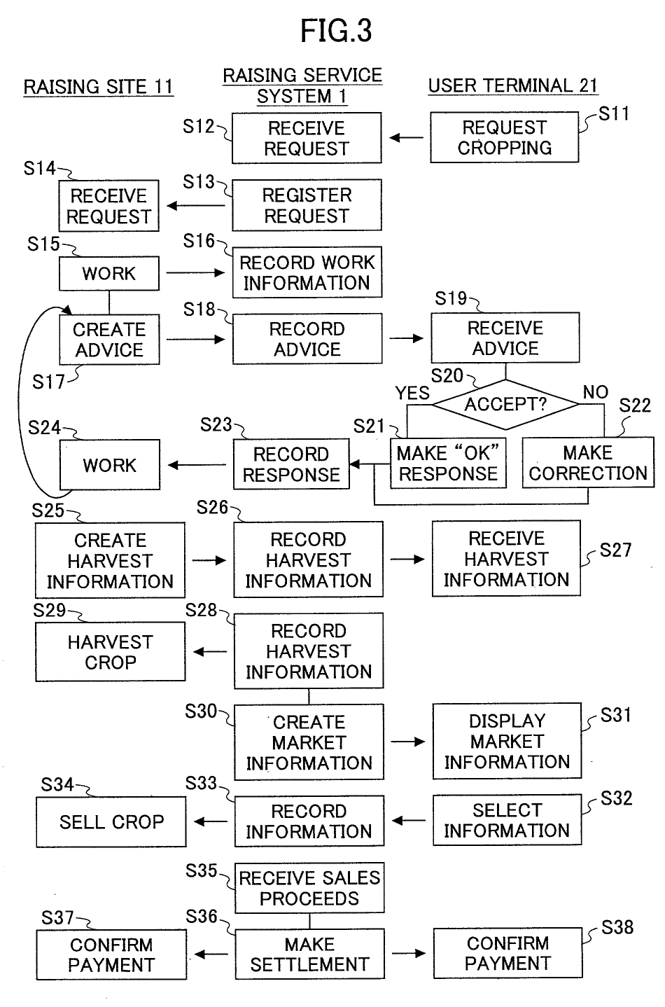

FIG. 3 is a flowchart of a general operation of the system of the present invention.

In step S1, the user terminal 21 is connected to the Web server of the raising service system 1 and makes a cropping request on the screen.

In step S12, the raising service system 1 receives the cropping request from the user.

In step S13, the raising service system 1 registers the received request (farm name, cropping acreage, period, crop) with the above-described customer database of FIG. 2B, and informs the raising site 11 of the cropping request from the user.

In step S14, the raising (farm) site 11 receives the user's cropping request transmitted from the raising service system 1.

In step S15, the raising site 11 works on the specified crop for the specified cropping acreage based on the received cropping request.

In step S16, the raising service system 1 is informed that cropping has been carried out in the raising site 11, and records this information in the customer database.

Thus, when the user makes a request for cultivation of the field crop, the raising service system 1 receives the request and instructs the raising site 11 to carry out cropping or cultivation through the above-described steps S11 through S16.

In step S17, the raising site 11 creates advice information and transmits the advice information to the raising service system 1.

In step S18, the raising service system 1 records the transmitted advice information of the past record, and transmits the transmitted advice information to the user terminal 21. Alternately, the raising service system 1 creates the advice information (advice information on additional manure, for instance) of the last year by referring to the database and transmits the created information to the user terminal 21.

In step S19, the user terminal 21 receives the advice information.

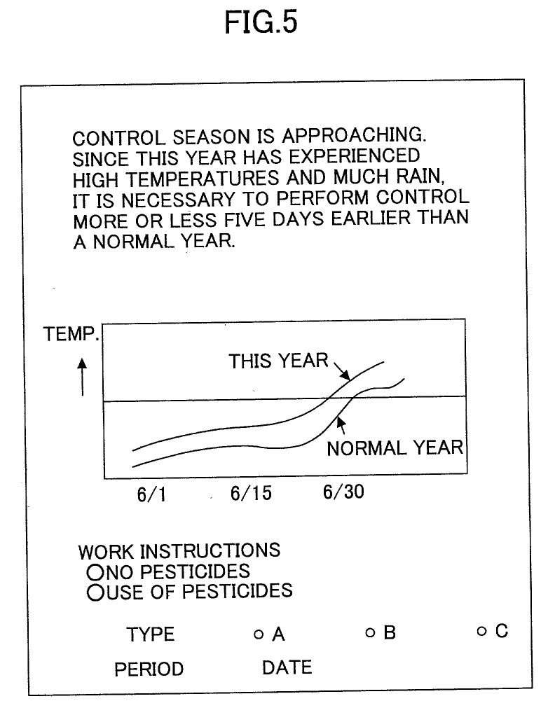

In step S20, the user terminal 21 displays the received advice information on the screen so that the user determines whether to accept the advice information. For instance, the user terminal 21 displays a later-described advice information of FIG. 5 so that the user determines whether to accept the advice information. If the user accepts the advice information (that is, “YES” in step S20), in step S21, the user terminal 21 makes an OK response and transmits the response to the raising service system 1. If the user does not accept the advice information (that is, “NO” in step S20), in step S21, the user terminal 21 corrects the advice information and transmits the corrected advice information (a correction response) to the raising service system 1.

In step S23, the raising service system 1 records the OK or correction response transmitted from the user terminal 21 and transfers the response to the raising site 11.

In step S24, the raising site 11 carries out work such as supplying additional manure to the field crop in accordance with the transferred user's response.

Thus, through the above-described steps S17 through S24, the raising site 11 makes advice information on work required during raising of the planted field crop, such as supplying additional manure thereto, the user is notified of the advice information, and the raising site 11 works in accordance with the OK or correction response from the user.

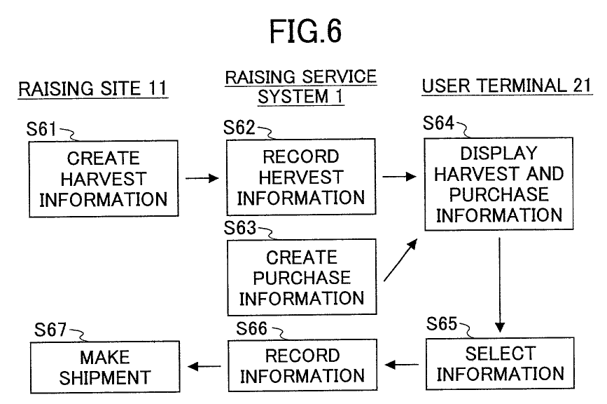

As will be described later in detail with reference to FIG. 6, steps S25 through S34 relate to the harvest of the field crop.

In step S25, the raising site 11 creates harvest information. In step S26, the raising service system 1 records the harvest information and transmits the harvest information to the user terminal 21. In step S27, the user terminal 21 receives and displays the harvest information.

After the raising service system 1 records the harvest information in step S28 (=step S26), in step S29, the raising site 11 harvests the field crop, while in step S30, the raising service system 1 creates market or purchase information and transmits the purchase information to the user terminal 21. The purchase information may be transmitted to the user terminal 21 together with the harvest information. In step S31, the user terminal 21 displays the purchase information. Then, in step S32, the user selects information from the purchase information and transmits the selected information to the raising service system 1. In step S33, the raising service system 1 records the selected information and transmits the information to the raising site 11. In step S34, the raising site 11 ships and sells the field crop in accordance with the selected information transmitted from the user terminal 21 via the raising service system 1.

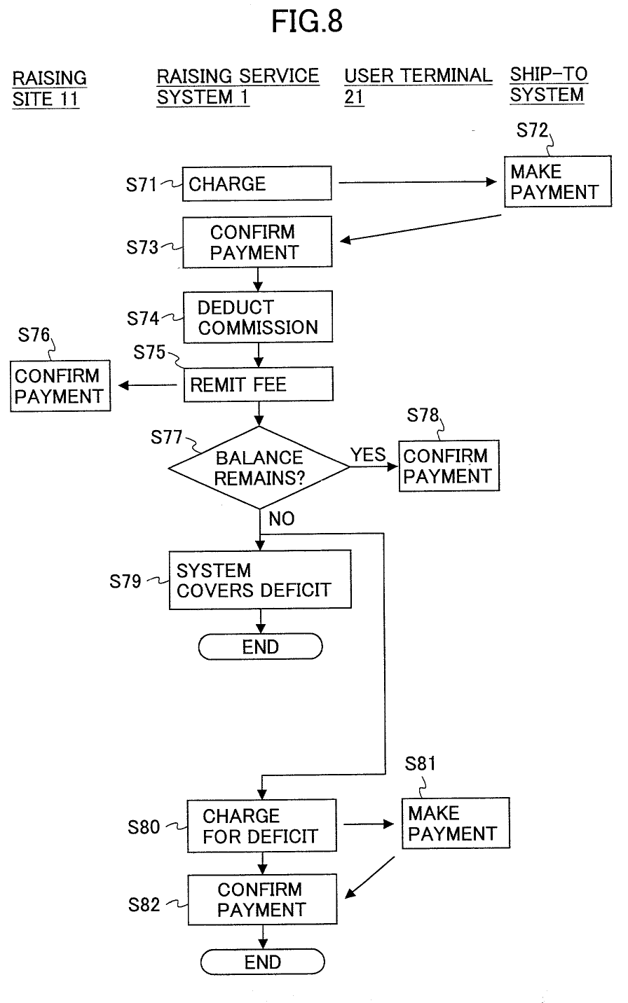

As will be described later in detail with reference to FIG. 8, steps S35 through S38 relates to settlement of account of this embodiment.

In step S35, the raising service system 1 receives the sales proceeds 34, and in step S36, makes settlement with respect to the sales proceeds 34 and remits payment to each of the raising site 11 and the user. In step S37, the raising site 11 confirms the payment, and in step S38, the user confirms the payment.

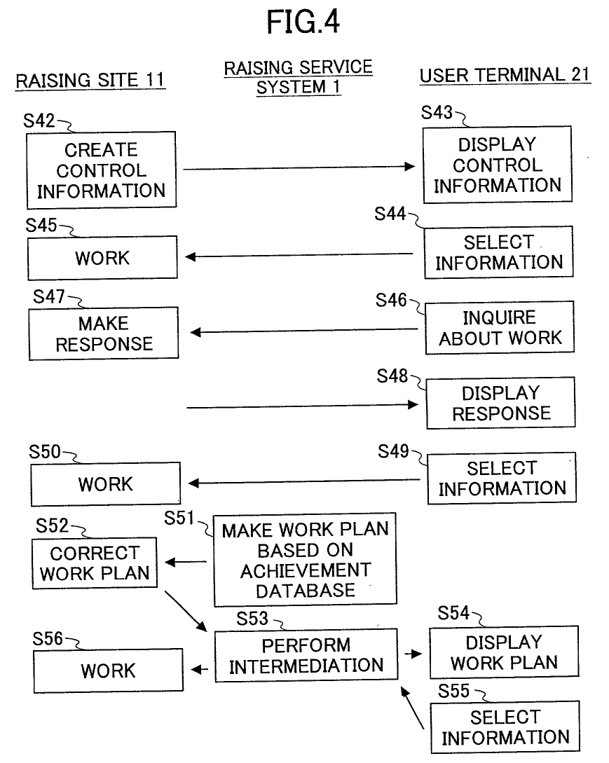

FIG. 4 is a flowchart of a raising-related operation of the system of the present invention.

In FIG. 4, a description will be given in detail of work for raising in the case of supplying additional manure.

In step S42, the raising site 11 creates control information as shown in the advice information of FIG. 5, for instance, and transmits the control information to the user terminal 21.

In step S43, the user terminal 21 displays the transmitted control information on the screen.

In step S44, the user selects items for selection in the control information displayed on the screen, and returns the selected items to the raising site 11.

In step S45, the raising site 11 works in accordance with the returned selections of the user.

Thus, through the above-described steps S42 through S45, the control information created by the professionals in the raising site 11 is transmitted to the user who has requested cropping, the user selects any items included in the control information or corrects the control information and transmits the selected items or the corrected control information to the raising site 11, and the professionals work based on the response from the user in the raising site 11.

In step S46, the user inputs inquiries about work on the screen and transmits the inquires to the raising site 11 by e-mail, for instance.

In step S47, the raising site 11 prepares a response to the work inquiries from the user and returns the response to the user.

In step S48, the user terminal 21 displays the returned response on the screen.

In step S49, the user selects items for selection from the information of the response from the raising site 11, and returns a response to the raising site 11.

In step S50, the raising site 11 works in accordance with the returned information.

Thus, through the above-described steps S46 through S50, the user makes the inquiries about work on the field crop that the user requested to be cropped, and returns the selected or corrected information based on the response from the raising site 11 so that the professionals therein work properly.

In step S51, the raising service system 1 makes a work plan based on an achievement database, and informs the raising site 11 of the work plan.

In step S52, the raising site 11 checks and corrects the work plan, and returns the work plan to the raising service system 1.

In step S53, the raising service system 1 transmits the returned work plan to the user terminal 21.

In step S54, the user terminal 21 displays transmitted work plan on the screen.

In step S55, the user selects appropriate items from the work plan displayed on the screen, and returns the selected information to the raising service system 1, which transfers the transmitted information to the raising site 11.

In step S56, the raising site 11 work in accordance with the selected items of the work plan.

Thus, after the work plan created by the raising service system 1 based on the achievement database is corrected by the knowledge of the professionals in the raising site 11, the work plan is transmitted to the user, and the user selects the appropriate items of the work plan and transmits the selected items to the raising site 11 so that the raising site 11 may work in accordance with the selected items of the work plan.

FIG. 5 is a diagram showing the advice information of the present invention.

The control information is written in the upper section of the advice information.

Provided in the middle section is weather information showing the transitions of temperature of a normal year and this year. The weather information indicates that control should be performed more or less five days earlier than the normal year since this year has experienced higher temperatures than the normal year.

The contents of work instructions are shown in the lower section so that the user can make selection on the following information:

no pesticides

use of pesticides

type A, B, C

period date.

Thus, the advice information created by the professionals of the raising site 11 is transmitted to and displayed on the user terminal 21 of the user who has requested cropping, and the user makes selection on the work instructions based on the advice information and information for decision-making such as the weather information so that the raising site 11 can work in accordance with the selection results.

FIG. 6 is a flowchart of a harvest-related operation of the system of the present invention.

In step S61, the raising site 11 creates harvest information and transmits the harvest information to the raising service system 1.

In step S62, the raising service system 1 records the harvest information transmitted from the raising site 11 in the database.

In step S63, the raising service system 1 creates purchase information, and transmits the harvest information and the purchase information to the user terminal 21.

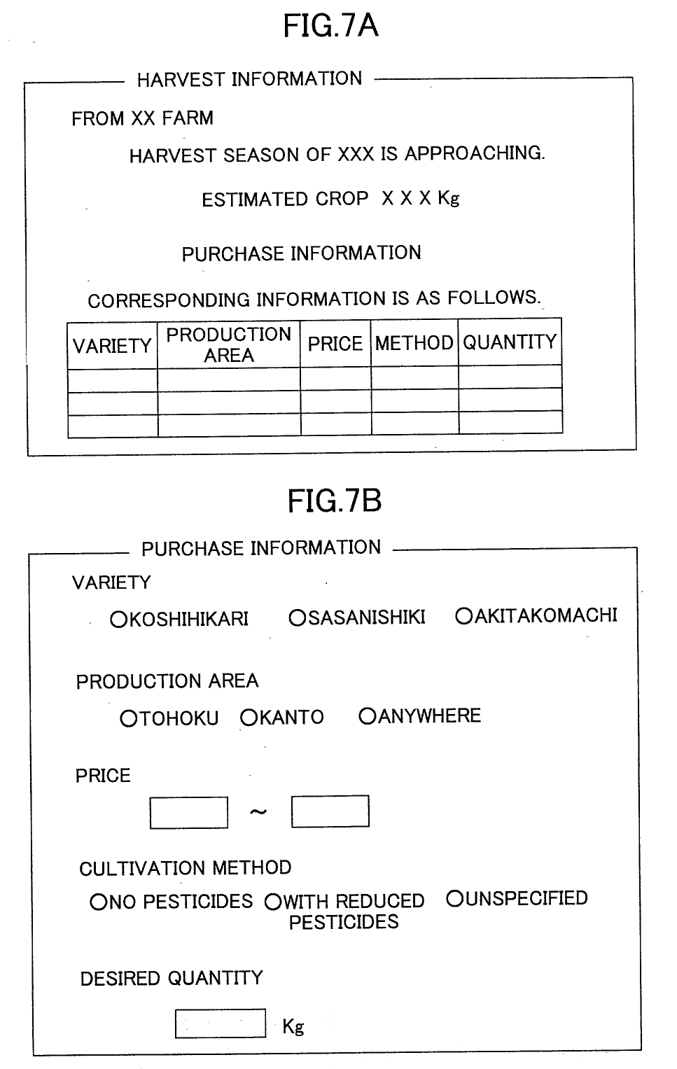

In step S64, the user terminal 21 displays the transmitted harvest and purchase information on the screen. For instance, the user terminal 21 displays later-described harvest information of FIG. 7A and purchase information of FIG. 7B together on the screen.

In step S65, the user selects items for selection on the purchase information of FIG. 7B and also inputs information to the input region of the purchase information. For instance, the user inputs minimum and maximum sales prices as required. Then, the user transmits a response to the purchase information to the raising service system 1.

In step S66, the raising service system 1 records the response to the purchase information from the user (user's purchase response) and transmits the user's response to the raising site 11.

In step S67, the raising site 11 ships the field crop in accordance with the user's purchase response transmitted from the raising service system 1. For instance, the raising site 11 ships the field crop to the general market 31 of FIG. 1 or the Internet sale 32. If the user expresses her/his intention to consume the field crop personally in the response, the raising site 11 ships a portion of the field crop for the personal consumption of the user to a place designated by the user.

Thus, when the shipment season of the raised field crop approaches, the raising site 11 creates the harvest information and the raising service system 1 further creates the purchase information. The raising service system 1 transmits the harvest and purchase information to the user who has requested cropping, and the raising site 11 makes shipment in accordance with the information selected or corrected by the user.

FIGS. 7A and 7B are diagrams showing the harvest information and the purchase information.

The harvest information of FIG. 7A includes the following information:

estimated crop

purchase information (variety, production area, price, method, quantity).

Thus, the raising site 11 creates the harvest information and, if required, the purchase information, and presents the user who has requested cropping with the information.

The purchase information of FIG. 7B includes the following information:

variety

production area

price

cultivation method

desired quantity.

By referring to the above-described purchase information, the selling price of the field crop (rice in this case) is determined.

FIG. 8 is a flowchart of a settlement-related operation of the system of the present invention.

In step S71, the raising service system 1 charges the system (for instance, the Internet sale 32) to which the shipment of the field crop was made (a ship-to system). That is, the raising service system 1 transmits a bill to the ship-to system for the shipment of the field crop shown in FIG. 6.

In step S72, the ship-to system pays the bill.

In step S73, the raising service system 1 confirms payment from the ship-to system.

In step S74, the raising service system 1 deducts the system commission (intermediation commission) from the payment.

In step S75, the raising service system 1 remits the raising fee to the raising site 11.

In step S76, the raising site 11 confirms the payment of the raising fee from the raising service system 1.

In step S77, the raising service system 1 determines whether a balance remains after the commission for the raising service system 1 and the fee for the raising site 11 are deducted from the sales proceeds that the ship-to system has deposited. If the balance remains (that is “YES” in step S77), the raising service system 1 remits the balance to the user as a dividend for the user. In step S78, the user confirms the payment of the dividend. On the other hand, if no balance remains or a deficit remains (that is, “NO” in step S77), in step S79, the raising service system 1 covers the deficit. Alternately, in step S80, the raising service system 1 transmits a bill to the user and charges the user for the deficit. In step S81, the user pays the deficit, and in step S82, the raising service system 1 confirms the payment from the user.

Thus, when the field crop raised at a cropping request of the user is shipped, the bill is transmitted to the ship-to system. When the ship-to system makes payment, the fee for the raising site 11 is deducted from the payment and transmitted to the raising site 11. Further, the commission for the raising service system is deducted from the payment. Thereafter, if a balance remains after deducting the fee and the commission from the payment, the balance is remitted to the user as a user's dividend, and if a deficit remains as a result of the deduction, in accordance with the contract between the user and the raising service system 1, the raising service system 1 covers the deficit or the raising service system 1 charges the user for the deficit and receives payment therefor. Thereby, the account is automatically settled with respect to the proceeds from the sale of the shipped field crop.

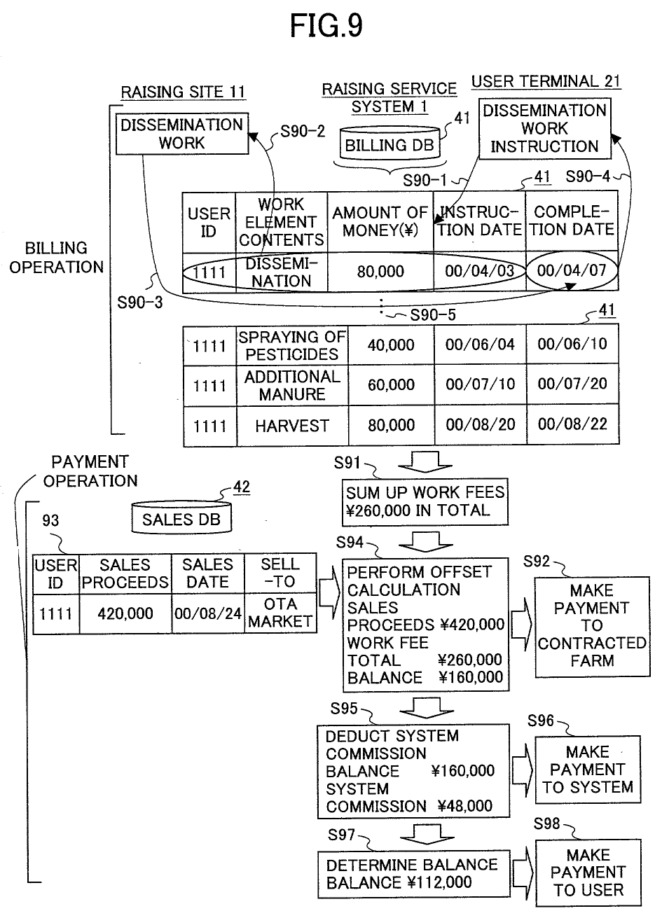

FIG. 9 is a flowchart of a billing-related operation of the system according to the present invention.

In step S90-1, the raising service system 1 creates billing information in response to an instruction on dissemination (seed planting) work given by the user terminal 21. The raising service system 1 creates a record of the following information in a billing database (DB) 41:

user ID: 1111

contents of work element: dissemination

amount of money: ¥80,000

date of instruction: 00/04/03

date of completion: -.

In step S90-2, the raising service system 1 makes a request for work to the raising site 11. The raising service system 1 requests the raising site 11 to carry out the contents of work specified by the user (dissemination in this case).

In step S90-3, the raising site 11 completes the dissemination work. The raising site 11, which is requested in step S90-2 to perform dissemination, performs dissemination and informs the raising service system 1 of the date of completion of the dissemination so that the raising service system 1 records the date of completion in the billing DB 41.

In step S90-4, the raising service system 1 informs the user terminal 21 of the completion of work. The raising service system 1 informs the user terminal 21 of the date of completion of work in response to recording of the date of completion of work in the billing DB 41 in step S90-3.

In step S90-5, the raising service system 1 records the billing information of each work element hereinafter in the billing DB 41 until harvest.

Through the above-described steps S90-1 through S90-5, information on contents of work element, date of completion, and amount of money of each work element from dissemination till harvest is accumulated successively as shown in the billing DB 41 in the center of FIG. 9.

In step S91, with respect to each user, the raising service system 1 sums up fees for the work elements from dissemination to harvest accumulated in the billing DB 41 through the above-described steps S90-1 through S90-5.

In step S93, the raising site 11 records the following information including proceeds from the sale of the raised field crop (for instance, fruit) in a sales database (DB) 42 as shown in FIG. 9.

user ID: 1111

sales proceeds: ¥420,000

date of sale: 00/08/24

sell-to: Ota Market.

In step S94, the raising service system 1 performs offset calculation. That is, the raising service system 1 subtracts the work fee total recorded in the billing DB 41 calculated in step S91 from the sales proceeds recorded in the sales DB 42 in step S93. For instance, the raising service system 1 subtracts a work fee total of ¥260,000 from sales proceeds of ¥420,000 to obtain a balance of ¥160,000.

In step S92, payment is made to the contracted farm (the raising site 11). That is, the amount of money obtained in step S91 is paid to the contracted farm. At this point, if the sales proceeds are smaller than the work fee total, based on the contract between the user and the raising service system 1, the raising service system 1 (a) collects a difference from the user and pays the difference to the contracted farm or (b) absorbs the difference by itself.

In step S95, the raising service system 1 deducts the system commission from the balance obtained in step S94. For instance, the raising service system 1 deducts a system commission of ¥48,000 from the balance of ¥160,000 and obtains a balance of ¥112,000.

In step S96, the system commission deducted in step S95 is paid to the raising service system 1.

In step S97, the raising service system 1 determines the balance of ¥112,000 remains in step S95 as the final balance.

In step S98, the raising service system 1 pays the final balance of ¥112,000 to the user.

Thus, the raising service system 1 accumulates the contents of work from dissemination to harvest and the corresponding work fees in the billing DB 41 and sums up the work fees. When the raising site 11 records the proceeds from the sale of the field crop in the sales DB 42, the raising service system 1 offsets the work fees by the sales proceeds and pays the work fees to the raising site 11 (contracted farm). Then, the raising service system deducts the system commission from the balance and the system commission is paid to the raising service system 1. Thereafter, if a balance still remains, the raising service system 1 pays the balance to the user as a dividend. At this point, if the balance is negative and there is no dividend for the user, the raising service system 1 absorbs the deficit or charges the user for the deficit based on the contract between the user and the raising service system 1.

In this embodiment, the raising instruction part 2 (see FIG. 1) of the raising service system 1 receives the raising instruction from the user terminal 21. The raising instruction part 2 transmits the instruction to the raising site 11 and causes the raising site 11 to raise the field crop specified by the user. The raising advice part 3 of the raising service system 1 receives the raising advice from the raising site 11 or creates the raising advice by referring to the database, and transmits the raising advice to the user terminal 21. Thereafter, the raising advice part 3 receives the response of the selected or corrected information from the user and transmits the response to the raising site 11 so that the raising site 11 can work accordingly.

Further, the harvest instruction part 4 of the raising service system 1 receives the harvest information from the raising site 11 and adds the purchase information, if necessary, to the harvest information. Then, the harvest instruction part 4 transmits the information to the user terminal 21 and receives the response of the selected and/or corrected information from the user. Thereafter, the harvest instruction part 4 transmits the response to the raising site 11 so that the raising site 11 harvests and ships the field crop accordingly.

Furthermore, the settlement part 5 of the raising service system 1 causes the raising site 11 to harvest and sell the raised product and deducts the intermediation commission and the fees for the raising site 11 from the proceeds from the sale of the raised product. Then, the settlement part 5 pays the fees to the raising site 11, and pays the balance to the user or charges the user.

As described above, according to the present invention, the raising service system 1 organically intermediates between the raising site 11 that raises a variety of products and the user who plays a key management role so that production, sale, and settlement can be realized with efficiency and simplicity.

The present invention is not limited to the specifically disclosed embodiment, but variations and modifications may be made without departing from the scope of the present invention.

The present application is based on Japanese priority application No. 2001-105094 filed on Apr. 3, 2001, the entire contents of which are hereby incorporated by reference.

What is claimed is:

1. A method of performing intermediation in raising a product, the method comprising the steps of:
(a) informing a raising site of an instruction transmitted from a user; and
(b) paying or charging the user based on a balance after deducting a fee for the raising site and an intermediation commission from proceeds from a sale of the product sold in accordance with the instruction of the user,
wherein said steps (a) and (b) are performed electrically via a network.

2. The method as claimed in claim 1, further comprising the step of (c) creating advice on raising the product in the raising site and transmitting the advice to the user,
wherein the fee for the raising site is determined based on the advice; and
said step (c) is performed electrically via the network.

3. The method as claimed in claim 2, further comprising the steps of:
(d) creating advice on raising the product by referring to a database; and
(e) informing the user of one or both of the advice created in said step (c) and the advice created in said step (d),
wherein said steps (d) and (e) are performed electrically via the network.

4. The method as claimed in claim 1, further comprising the step of (c) determining whether the balance is positive or negative,
wherein said step (b) pays the balance to the user if the balance is positive and charges the user for the balance when the balance is negative.

5. The method as claimed in claim 1, wherein the product is sold to the user for personal consumption.

6. The method as claimed in claim 1 wherein the product is sold to a consuming public via a sales system using the Internet.

7. The method as claimed in claim 1, wherein the product is sold to the user for personal consumption and to a consuming public via a sales system using the Internet.

8. The method as claimed in claim 1, wherein the proceeds are transmitted from the raising site.

9. The method as claimed in claim 1, wherein the proceeds are transmitted from a sales system using the Internet.

10. The method as claimed in claim 1, wherein the network is the Internet.

11. The method as claimed in claim 1, further comprising the step of (c) the user specifying the product to be raised,
wherein said step (c) is performed electrically via the network.

12. A method of performing intermediation in raising a product, the method comprising the steps of:
(a) informing a user of harvest information transmitted from a raising site with sales conditions being added to the harvest information as required; and
(b) informing the raising site of a response from the user to the sales conditions so that the raising site sells the product in accordance with the response from the user,
wherein said steps (a) and (b) are performed electrically via a network.

13. The method as claimed in claim 12, further comprising the step of (c) the user making the response by selecting information from the sales conditions and/or correcting the sales conditions.

14. The method as claimed in claim 12, wherein the network is the Internet.

15. A method of performing intermediation in raising a product, the method comprising the steps of:
(a) informing a user of one or both of advice on raising the product transmitted from a raising site and advice on raising the product created by referring to a database; and
(b) informing the raising site of a response from the user to the advice so that the raising site raises the product in accordance with the response from the user,
wherein said steps (a) and (b) are performed electrically via a network.

16. The method as claimed in claim 15, further comprising the step of (c) the user determining whether to accept or correct the transmitted advice and making the response based on the determination.

17. The method as claimed in claim 15, further comprising the step of (c) the user making the response by selecting information from the advice and/or correcting the advice.

18. The method as claimed in claim 15, wherein the network is the Internet.

19. A program for performing intermediation in raising a product, the program causing a computer to execute the steps of:
(a) informing a raising site of an instruction transmitted from a user; and
(b) paying or charging the user based on a balance after deducting a fee for the raising site and an intermediation commission from proceeds from a sale of the product sold in accordance with the instruction of the user,
wherein said steps (a) and (b) are performed via a network.

20. The program as claimed in claim 19, causing the computer to further execute the step of (c) creating advice on raising the product in the raising site and transmitting the advice to the user,
wherein the fee for the raising site is determined based on the advice; and
said step (c) is performed electrically via the network.

21. The program as claimed in claim 20, causing the computer to further execute the steps of:
(d) creating advice on raising the product by referring to a database; and
(e) informing the user of one or both of the advice created in said step (c) and the advice created in said step (d),
wherein said steps (d) and (e) are performed electrically via the network.

22. The program as claimed in claim 19, causing the computer to further execute the step of (c) determining whether the balance is positive or negative,
wherein said step (b) pays the balance to the user if the balance is positive and charges the user for the balance when the balance is negative.

23. The program as claimed in claim 19, wherein the product is sold to the user for personal consumption.

24. The program as claimed in claim 19, wherein the product is sold to a consuming public via a sales system using the Internet.

25. The program as claimed in claim 19, wherein the product is sold to the user for personal consumption and to a consuming public via a sales system using the Internet.

26. The program as claimed in claim 19, wherein the proceeds are transmitted from the raising site.

27. The program as claimed in claim 19, wherein the proceeds are transmitted from a sales system using the Internet.

28. The program as claimed in claim 19, wherein the network is the Internet.

29. The program as claimed in claim 19, wherein the user specifies the product to be raised electrically via the network.

30. A computer-readable recording medium storing a program for performing intermediation in raising a product,
the program causing a computer to execute the steps of:
(a) informing a raising site of an instruction transmitted from a user; and
(b) paying or charging the user based on a balance after deducting a fee for the raising site and an intermediation commission from proceeds from a sale of the product sold in accordance with the instruction of the user,
wherein said steps (a) and (b) are performed via a network.

31. The recording medium as claimed in claim 30, wherein the program causes the computer to further execute the step of (c) creating advice on raising the product in the raising site and transmitting the advice to the user;
the fee for the raising site is determined based on the advice; and
said step (c) is performed electrically via the network.

32. The recording medium as claimed in claim 31, wherein the program causes the computer to further execute the steps of:
(d) creating advice on raising the product by referring to a database; and
(e) informing the user of one or both of the advice created in said step (c) and the advice created in said step (d); and
said steps (d) and (e) are performed electrically via the network.

33. The recording medium as claimed in claim 30, wherein the program causes the computer to further execute the step of (c) determining whether the balance is positive or negative; and
said step (b) pays the balance to the user if the balance is positive and charges the user for the balance when the balance is negative.

34. The recording medium as claimed in claim 30, wherein the product is sold to the user for personal consumption.

35. The recording medium as claimed in claim 30, wherein the product is sold to a consuming public via a sales system using the Internet.

36. The recording medium as claimed in claim 30, wherein the product is sold to the user for personal consumption and to a consuming public via a sales system using the Internet.

37. The recording medium as claimed in claim 30, wherein the proceeds are transmitted from the raising site.

38. The recording medium as claimed in claim 30, wherein the proceeds are transmitted from a sales system using the Internet.

39. The recording medium as claimed in claim 30, wherein the network is the Internet.

40. The recording medium as claimed in claim 30, wherein the user specifies the product to be raised electrically via the network.
